(19) United States
(12) Patent Application Publication
(10) Pub. No.: US 2011/0189405 A1
(43) Pub. Date: Aug. 4, 2011

(54) Powder Feeder for Plasma Spray Gun

(75) Inventors: Raanan Y. Zehavi, San Jose, CA (US); Sharone Zehavi, San Jose, CA (US)

(73) Assignee: INTEGRATED PHOTOVOLTAIC, INC., San Jose, CA (US)

(21) Appl. No.: 13/019,965

(22) Filed: Feb. 2, 2011

Related U.S. Application Data
(60) Provisional application No. 61/300,804, filed on Feb. 2, 2010.

(51) Int. Cl. C23C 4/04; B05C 11/11; B05C 11/00

(52) U.S. Cl. 427/452; 118/723 R; 118/712

(57) ABSTRACT

The instant invention discloses a method of generating silicon powder aerosol to maintain cleanliness of the silicon powder during the feed process which utilizes an carrier gas, optionally, inert, and non-contaminating feed line to a plasma spray gun.

### PRIORITY

This application claims priority from U.S. Provisional Applications 61/300,804 filed on Feb. 2, 2010.

### CROSS-REFERENCE TO RELATED APPLICATIONS

This application is related in part to U.S. Pat. No. 7,789,331 and U.S. application Ser. Nos. 11/782,201, 12/074,651, 12/720,153, 12/749,160, 12/789,357, 12/860,048, 12/860,088 and 13/010,700, all owned by the same assignee and incorporated by reference in their entirety herein. Additional technical explanation and background is cited in the referenced material.

### BACKGROUND OF THE INVENTION

1. Field of the Invention

The invention relates generally to a powder feeder for a plasma spray gun capable of delivering silicon powder at a predetermined rate.

2. Description of Related Art

Photovoltaic solar cells are semiconductor devices that convert photons into electrical energy. Much literature exists on the methods of manufacture and the performance of solar cells. NREL (National Renewable Energy Laboratory) of the US Dept of Energy frequently updates a chart of the best efficiencies achieved for photovoltaic devices in research labs. This chart is available online: nrel.govincpv/thin_film/docs/kaz_best_research_cells.ppt

From these measurements we see that, for single junction cells, single crystalline silicon is consistently the most efficient material for solar cells in terms of light to electricity conversion. For the purposes of mass production of solar cells, single crystal silicon is at a disadvantage in terms of cost. Thin film devices, while less efficient in the conversion of light into electricity, are much more cost effective for mass production.

Additional attempts to demonstrate the feasibility of depositing a photoactive layer on inexpensive substrates to significantly reduce the cost of mass production of solar cells have been documented by Tamura, Fumitaka, et al.; “Fabrication of poly-crystalline silicon films using plasma spray method”; Solar Energy Materials and Solar Cells 34 (1994) 263-270.

Novel improvements to the deposition techniques proposed by Tamura have been demonstrated by Zehavi et al. in U.S. Pat. No. 7,789,331, U.S. 2008/0220558 and U.S. Ser. No. 12/860,048. A key parameter for effective implementation of plasma spray for active layer deposition is a method for feeding silicon powder into the plasma spray gun while maintaining the powder at semiconductor level cleanliness.

Prior art is found in the following references, U.S. Pat. No. 3,909,068, U.S. Pat. No. 5,013,883, U.S. Pat. No. 5,408,066, U.S. Pat. No. 7,758,838, and U.S. 2010/0200549; all incorporated herein by reference in their entirety.

### BRIEF SUMMARY OF THE INVENTION

The invention relates generally to deposition of thin films onto substrates, optionally, conductive, by a plasma spray. In particular, the invention relates to a powder feeder for a plasma spray gun for deposition of a layer of highly conductive, doped silicon onto an, optionally, conductive substrate. The process disclosed is a thermal plasma spray requiring silicon powder delivered to a plasma spray gun. The instant invention discloses a unique method of generating a silicon powder aerosol to maintain cleanliness of the silicon powder during the feed process which utilizes an carrier gas, optionally, inert, and non-contaminating feed line to the plasma. A silicon powder aerosol is created by a combination of pressure feeding a carrier gas through a bed of the silicon powder and a vibrator motion preventing the silicon powder from clumping together. Once in aerosol form, silicon powder is carried by the pressurized carrier gas to the plasma gun via a feed line.

### BRIEF DESCRIPTION OF THE SEVERAL VIEWS OF THE DRAWING(S)

FIG. 1 shows a jet mill for making silicon powder from U.S. Pat. No. 7,789,331.

FIG. 2 shows exemplary plasma spray gun U.S. 2008/0220558.

FIG. 3 shows exemplary powder injector U.S. 2008/0220558.

FIGS. 4a, b, and c show exemplary embodiments of the instant invention.

### DETAILED DESCRIPTION OF THE INVENTION

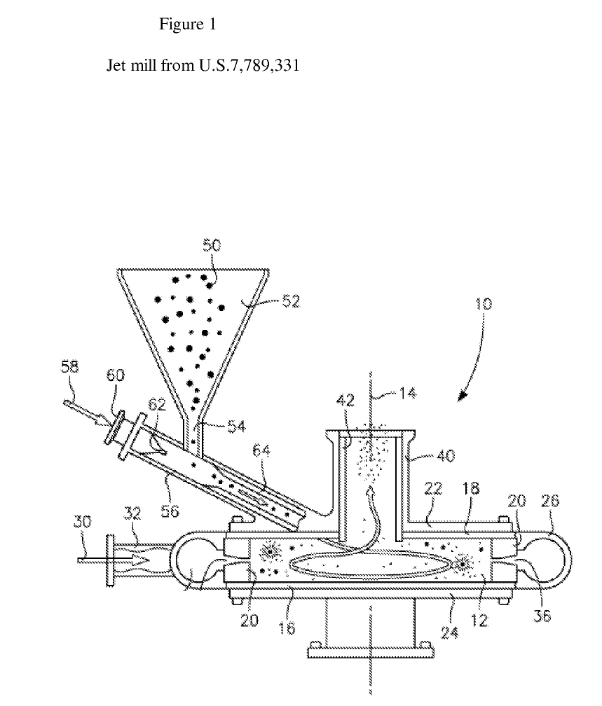

As described in U.S. Pat. No. 7,789,331, jet milling may be used to pulverize silicon pellets into a fine silicon powder. Jet mills of differing capacities are available under the trade name Micronizer® from Sturtevant, Inc. of Hanover, Mass. The operation of such a jet mill 10 is illustrated in the partially sectioned view of FIG. 1.

Pellets 50 of the desired material, in this case, silicon are loaded into a feed funnel 52 having a narrow feed orifice 54 at its bottom to slowly feed the pellets 50 into a feed tube 56, which is part of the upper mill body 22. Compressed feed gas 58 is supplied to a feed gas inlet 60 having a nozzle 62 directing the feed gas 58 toward the pellets 50 falling with them through the feed orifice 54 of the funnel 52. The feed gas 58 entrains the pellets 50 and flows through the bore of a tubular supply liner 64 and through the upper wall liner 18 into the milling chamber 12. The liner 64 acts as an injector injecting the feed gas 58 and entrained pellets 50 into the vortex within the milling chamber 12.

A swirling vortex accelerates the pellets 50 into a generally circular path within the milling chamber 12. The pulverization of material primarily occurs from particle-to-particle impact although some particles do strike the liners, particularly the circumferential liner 20. The tangential velocity of the vortex generally increases towards the chamber central axis 14. Centrifugal force drives larger particles towards the perimeter while fine particles are swept by the gas vortex and move toward the chamber central axis 14 and exit the milling chamber 12 through the vortex finder 42 within the outlet 40 together with the two gases 30, 58.

Conventionally, the wall liners 16, 18, 20 are made of stainless steel although other materials are also conventionally used to reduce corrosion. However, we observe that for semiconductor applications, the heavy metals in stainless steel including iron, nickel, and chromium are likely to contaminate the silicon powder and eventually contaminate the silicon integrated circuit.

According to one aspect of the invention, the wall liners 16, 18, 20, supply liner 64, vortex finder 42 and other components to which the pellets 50 and milled powder are exposed, particularly at high velocity, are composed of silicon, preferably high-purity silicon. EGS-grade silicon, also known as virgin polysilicon, may be used. It has an extremely high purity level and tends to fracture easily. A silicon part or feed stock according to the invention has a silicon fraction of more than 99 at %; EGS-grade silicon is known to have heavy and alkali metal impurity levels of less than 10⁻⁹ atomic or <1 ppba. However, other forms of silicon may be used to form the high-purity silicon chamber parts, such as cast silicon, plasma sprayed silicon, and either monocrystalline or polycrystalline Czochralski-grown silicon. An especially convenient and inexpensive form of polysilicon is randomly oriented polysilicon (ROPSi) described in U.S. patent application 2006/0211128, incorporated herein by reference. ROPSi is grown from a silicon melt by the Czochralski method using a randomly oriented seed. Depending upon its growth conditions, it may need to be annealed prior to machining. In some embodiments an all-silicon liner assembly including the first and second axial liners and a circumferential liner for lining the walls of the milling chamber and the vortex finder is required.

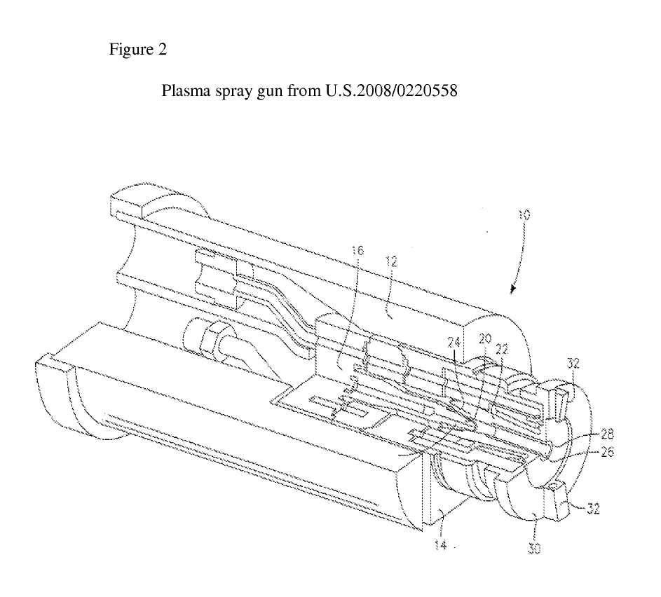

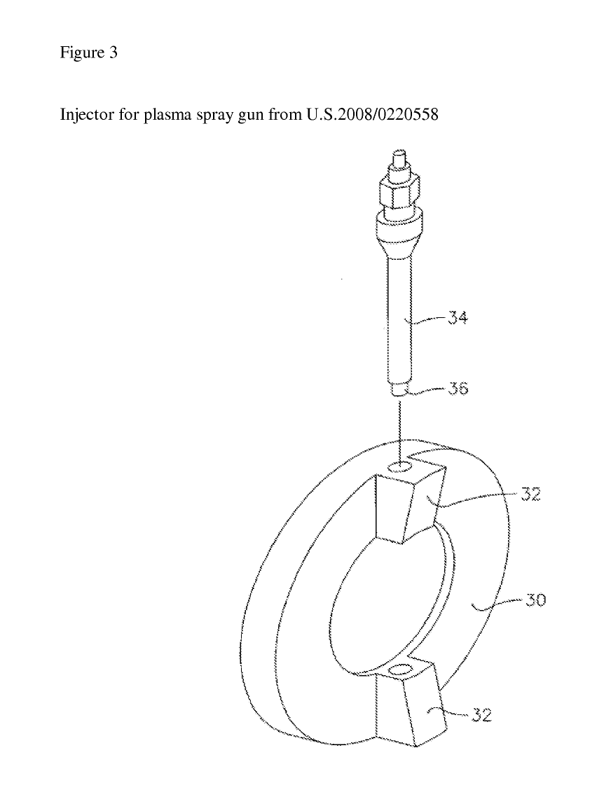

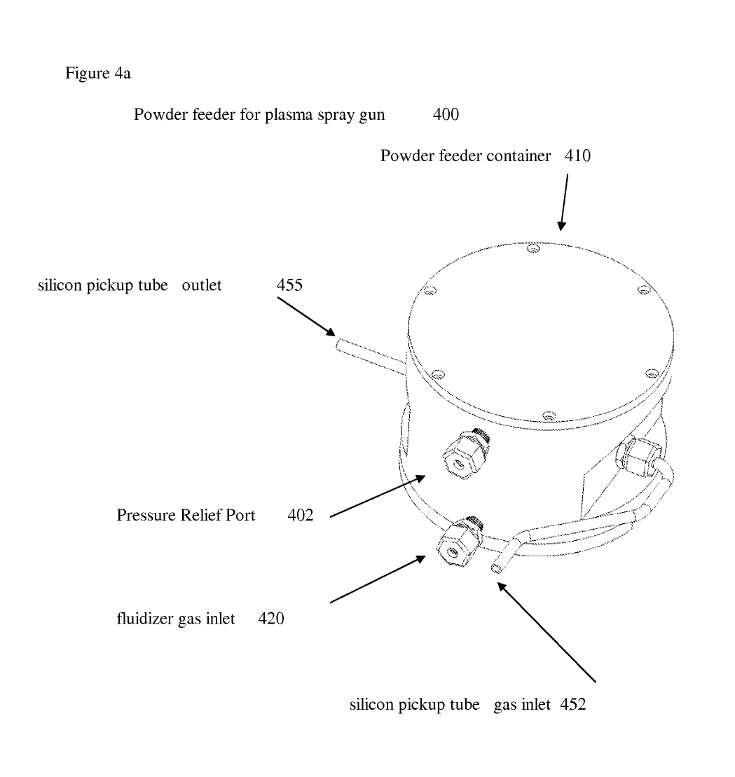

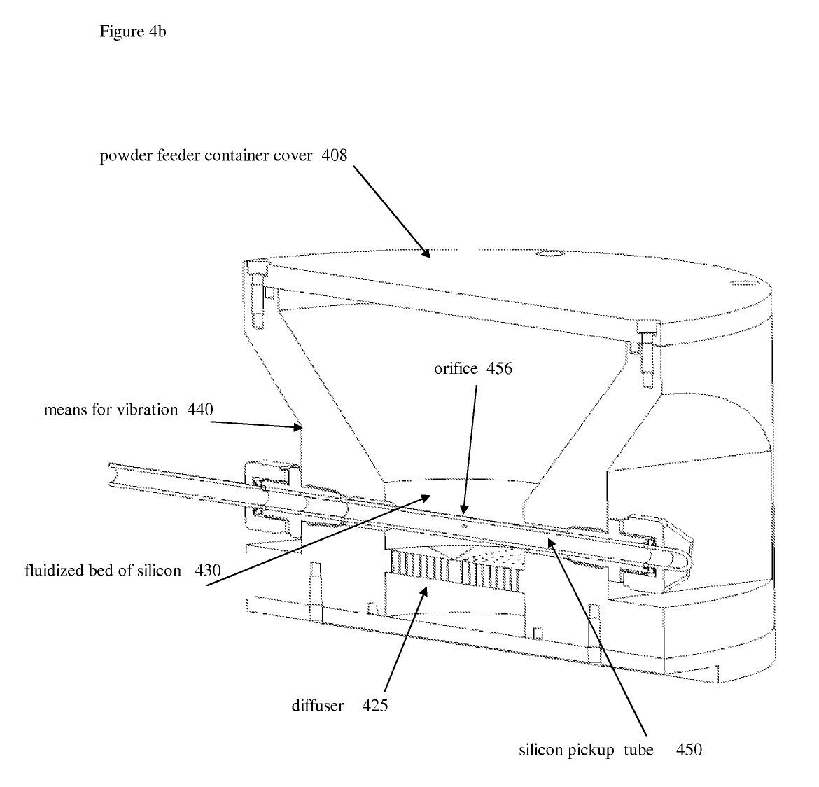

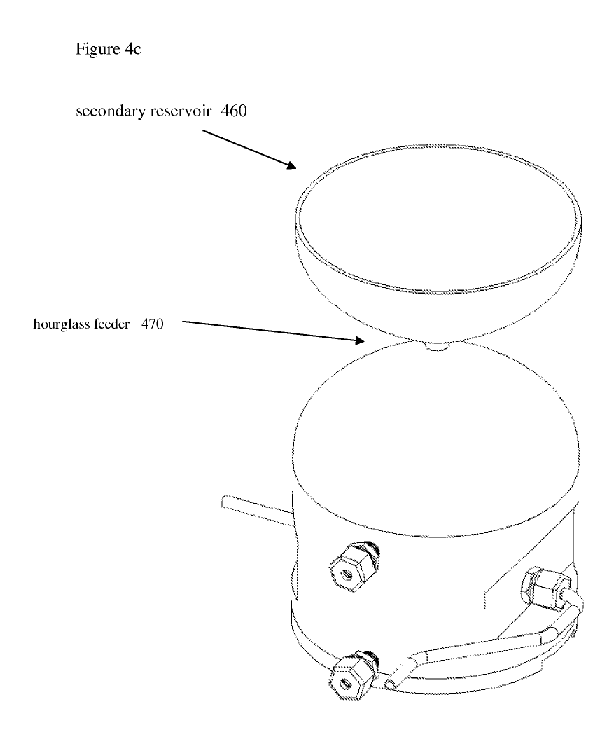

Not disclosed in U.S. Pat. No. 7,789,331 and U.S. 2008/0220558 is a powder feeder for a plasma spray gun. Novel improvements to a process encompassing the inventions of U.S. Pat. No. 7,789,331 and U.S. 2008/0220558 are disclosed in FIGS. 4a, b and c. A powder feeder for a plasma spray gun 400 comprises a powder feeder container 410 with a fluidizer gas inlet 420. Gas inlet 420 enters container 410 below diffuser 425, shown in FIG. 4b; diffuser or frit 425 has multiple flow channels in order to create a fluidized bed of silicon particles 430 above the diffuser. Diffuser 425 may be made of silicon, quartz, titanium, silicon carbide, boron nitride or other non-contaminating carbide or nitride based material; optionally, a diffuser may be a “silicon frit” or “silicon diffuser” made by laser drilling small passages in a silicon slab. A silicon pickup tube itself may be made of silicon, quartz, titanium, silicon carbide, boron nitride or other non-contaminating carbide or nitride based material. Silicon powder bed fluidization is assisted by a means for vibrating 440 impacting feeder container 410 causing the silicon powder to remain in motion and not clump together. A means for vibrating 440 may be a piezo actuator, an ultrasonic actuator, or other mechanically, pneumatically, or electrically actuated device to impart vibration in a frequency range between about 10 Hz and 10 kHz placed in one or more locations, not shown, around the feeder container. Carrier gas pressure is adjusted so that a portion of the silicon is turned into an aerosol and flows with the carrier gas via silicon pickup tube outlet 455 from the chamber into the plasma jet powder injector 34 of FIG. 3; in some embodiments silicon pickup tube outlet 455 may connect to alternative locations of plasma spray gun of FIG. 2.

Orifice 456 is placed in silicon pickup tube 450 above diffuser 425 such that silicon powder from fluidized bed 430 enters silicon pickup tube based on a pressure differential between the two chambers. Gas inlet 420 is at a pressure between about 10 psig and 100 psig; pressure relief port 402 enables regulation of pressure differential between gas inlet 452 and gas outlet 455 and orifice 456; orifice size may be adjusted depending on flow rate; silicon particle size and quantity of silicon, g/min, delivered to injector. Optionally, orifice 456 may be a venturi tube; a venturi enables a larger pressure differential between the fluidized bed pressure and the pressure inside the silicon pickup tube which can increase the grams per second of silicon powder injected into a plasma spray gun. In some embodiments a pressure sensor is placed inside the chamber to monitor the fluidized bed pressure; optionally, a pressure sensor is placed inside the silicon pickup tube to monitor the tube pressure; optionally, a pressure sensor is placed inside the pressure relief line to monitor the relief pressure; optionally, pressure sensors are centrally monitored and gas supply lines and exhaust valves are controlled at predetermined values in order to control the grams per minute of silicon being injected into a plasma spray gun. Quantity of silicon fed into a plasma jet of FIG. 2 is controlled by pressure and/or flow controllers, not shown, on the carrier gases and relief port.

In some embodiments the amount of silicon delivered to a plasma gun by the plasma feeder of the instant invention can be controlled from about 0.1 g/min to about 50 g/min.; in some embodiments the amount of silicon delivered to a plasma gun by the plasma feeder of the instant invention can be controlled from about 0.1 g/sec to about 10 g/sec. Practical density of the silicon aerosol ranges from about 0.01 grams of silicon per liter to about 1.0 grams per liter. Silicon delivery rates are in a range such that a 25 micron thick layer may be deposited on a 150 mm wafer in less than about 2 min.; optionally, a 100 micron layer may be deposited on a 1 meter wide substrate at a feed rate of more than 10 cm/min.

Optionally, a feeder container and all components in contact with a silicon fluidized bed may be made of silicon, high purity quartz, titanium, silicon carbide, boron nitride or other non-contaminating carbide or nitride based material; optionally, just a liner of silicon, high purity quartz, titanium, silicon carbide, boron nitride or other non-contaminating carbide or nitride based material may be used inside various components such as for the feeder container 410 such that silicon powder contacts only preferred materials. Optionally, silicon powder of the instant invention comes in contact only with material chosen from a group consisting of silicon, quartz, titanium, silicon carbide, boron nitride metal carbides and metal nitrides based between a silicon powder feeder and being injected into a plasma spray. By using quartz feed tubes, for example, there is no significant contamination of the silicon due to abrasion of the tubes by the silicon flowing through the feed tube. By using a secondary reservoir 460 of silicon powder with a uniform control of the feed into the primary container, using, for example gravity in an “hourglass” type of feeder 470, the level of silicon in the fluidized bed for feeding into the plasma can remain constant.

In some embodiments silicon powder is of a diameter from about 50 microns to about 500 microns; in some embodiments silicon powder is of a diameter from about 50 microns to about 100 microns. In some embodiments silicon powder is not doped; in some embodiments at least a portion of the silicon powder is doped n-type; in some embodiments at least a portion of the silicon powder is doped p-type. In some embodiments silicon powder is mixed with carbon powder; in some embodiments silicon powder is mixed with carbon nanotubes.

It will be understood that when an element as a layer, region or substrate is referred to as being “on” or “over” or “adjacent” another element, it can be directly on the other element or intervening elements may also be present. In contrast, when an element is referred to as being “directly on” or “directly over” or “in contact with” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The foregoing described embodiments of the invention are provided as illustrations and descriptions. They are not intended to limit the invention to a precise form as described. In particular, it is contemplated that functional implementation of invention described herein may be implemented equivalently in various combinations or other functional components or building blocks. Other variations and embodiments are possible in light of above teachings to one knowledgeable in the art of semiconductors, thin film deposition techniques, and materials; it is thus intended that the scope of invention not be limited by this Detailed Description, but rather by Claims following.

We claim:

1. A method of feeding silicon powder into thermal plasma spray comprising the steps:
flowing a carrier gas through a diffuser into silicon powder;
creating a silicon aerosol by lifting a portion of the powder with the gas as it flows through the diffuser;
vibrating with a means for vibration such that the silicon powder does not clump; and
flowing the carrier gas and silicon aerosol into a silicon pickup tube; and
injecting the silicon powder into the thermal plasma spray.

2. The method of claim 1 wherein the carrier gas is one or more chosen from a group consisting of argon, helium, hydrogen and nitrogen.

3. The method of claim 1 wherein the silicon pickup tube is made of a material chosen from a group consisting of silicon, quartz, titanium, silicon carbide, boron nitride metal carbides and metal nitrides based.

4. The method of claim 1 wherein the feed rate of silicon is between about 0.1 g/min. and about 100 g/min.

5. The method of claim 1 wherein the silicon is replenished to the feeder using a gravity controlled “hourglass”.

6. The method of claim 1 wherein the silicon powder diameter varies from about 50 microns to about 100 microns.

7. The method of claim 1 wherein the silicon aerosol has a practical density in a range from about 0.01 g/L to about 1 g/L.

8. The method of claim 1 wherein the diffuser is made of a material chosen from a group consisting of silicon, quartz, titanium, silicon carbide, boron nitride metal carbides and metal nitrides based.

9. The method of claim 1 wherein the silicon powder comes in contact only with material chosen from a group consisting of silicon, quartz, titanium, silicon carbide, boron nitride metal carbides and metal nitrides based.

10. An apparatus for feeding silicon powder in a carrier gas to a plasma spray gun comprising:
feeder container;
carrier gas input tube;
means for fluidizing silicon powder comprising a diffuser; and
silicon pickup tube comprising an orifice wherein the carrier gas enters the feeder container through a carrier gas input tube and enters a means for fluidizing silicon powder comprising a diffuser and exits the feeder container through a silicon pickup tube comprising an orifice with a predetermined amount of silicon powder entrained and enters the plasma spray gun.

11. The apparatus of claim 10 further comprising a means for vibrating wherein the means for vibrating impacts the feeder container at a frequency between about 10 Hz and 10 kHz such that the silicon powder does not clump together.

12. The apparatus of claim 10 wherein the silicon pickup tube comprises a venturi tube.

13. The apparatus of claim 10 further comprising a secondary reservoir with an hour glass feeder such that silicon powder exits the secondary reservoir through the hourglass feeder and enters the feeder container at a rate between about 0.1 g/min to about 50 g/min.

14. The apparatus of claim 10 wherein the feeder container, the diffuser and the silicon pickup tube are of a material chosen from a group consisting of silicon, quartz, titanium, silicon carbide, boron nitride metal carbides and metal nitrides based.

15. The apparatus of claim 10 wherein the feeder container has a liner of a material chosen from a group consisting of silicon, quartz, titanium, silicon carbide, boron nitride metal carbides and metal nitrides based such that the silicon powder comes in contact with the liner.

16. The apparatus of claim 10 further comprising a pressure sensor internal to the feeder container such that the flow of silicon powder out of the feeder container may be determined.
